(19) United States
(12) Patent Application Publication
(10) Pub. No.: US 2009/0181667 A1
(43) Pub. Date: Jul. 16, 2009

(54) Mobile communication apparatus and operating method thereof

(75) Inventor: Ming-Jun Lin, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/314,191

(22) Filed: Dec. 5, 2008

(30) Foreign Application Priority Data
Dec. 5, 2007 (TW) 096146230

(51) Int. Cl. H04W 4/00; H04M 1/00

(52) U.S. Cl. 455/432.1; 455/566; 455/435.3

(57) ABSTRACT

A mobile communication apparatus is disclosed. The mobile communication apparatus comprises a selecting module, a registering module, and a judging module. The selecting module is used for selecting a first preferred network from at least one communication network near the mobile communication apparatus. A first network registration is performed on the first preferred network by the registering module. When the first network registration is rejected by the first preferred network, the judging module is used for judging whether the mobile communication apparatus is under a roaming state. If the judgment of the judging module is yes, the selecting module is operated by the judging module to reselect a second preferred network.

### BACKGROUND OF THE INVENTION

1. Field of the Invention

The invention relates to a mobile communication apparatus, and more particularly, to a mobile communication apparatus and a mobile communication apparatus operating method for improving the current network roaming services.

2. Description of the Prior Art

With the rapid growth of mobile communication technology, a mobile roaming service is provided by most mobile communication service providers. With this mobile roaming service, users can use their own mobile phone numbers to access mobile communication network service provided by another mobile communication service provider in a foreign area. Thus, users will not meet a condition that no mobile network service is available in the foreign area.

The roaming of the mobile phone is based on the protocols signed among different mobile network service providers. After a network registering procedure is performed to confirm a user's ID, then, the user of the mobile communication network service provider A can use his/her mobile to access the network resource provided by another mobile communication network service provider B via the mobile network of the mobile communication network service provider B.

The roaming service provided by the mobile communication network service provider is very convenient to users, especially to the businessman who often takes business trips to foreign countries. Additionally, because the progress of the mobile communication technology, many communication service providers have already provided the 2G mobile communication network service and the 3G mobile communication network service at the same time. And, the dual-mode mobile phones supporting both 2G network and 3G network become more and more popular on the market.

In practical applications, when a user uses a 2G/3G dual mode mobile phone to perform a roaming function, it is possible that the mobile phone can not connect to any mobile communication networks, so that the mobile phone fails to be used. The possible cause of this failure condition is that when the user uses the 2G/3G dual mode mobile phone to roam, the mobile phone receives a stronger 3G network signal than a 2G network signal, so that the mobile phone will register on the 3G network firstly.

However, the local communication service provider may provide the 2G network roaming service only instead of the 3G network roaming service. Therefore, based on a general 3G network registering procedure (e.g., a Third Generation Partnership Project, 3GPP), the mobile phone will be rejected by the 3G network and then the mobile phone will receive a rejection code of “illegal mobile phone”. This rejection code causes that the mobile phone can not use any network services except to make an emergency call until the user resets the mobile phone, and can not select other 2G networks which can provide the mobile phone the roaming service. This condition will make the user inconvenient when he/she uses the roaming function of the mobile phone.

Therefore, the invention provides a mobile communication apparatus and operating method thereof to solve the above-mentioned problems.

### SUMMARY OF THE INVENTION

The invention provides a mobile communication apparatus and operating method thereof. The mobile communication apparatus and operating method thereof can solve the problem that when the mobile communication apparatus performs a roaming function, the registration of the mobile communication apparatus is rejected and the mobile communication apparatus can not use any network services.

A preferred embodiment according to the invention is a mobile communication apparatus. The mobile communication apparatus comprises a selecting module, a registering module, and a judging module. The selecting module is used for selecting a first preferred network from at least one communication network near the mobile communication apparatus. The registering module performs a first network registration on the first preferred network. When the first network registration is rejected by the first preferred network, the judging module is used for judging whether the mobile communication apparatus is under a roaming state. If the judgment of the judging module is yes, the selecting module is operated by the judging module to reselect a second preferred network.

In practical applications, when the registration of the mobile communication apparatus on a 3G network is rejected, whether the mobile communication apparatus is under a roaming state will be judged to determine whether the mobile communication apparatus reselects another 2G network to register. By doing so, the failure condition of the mobile phone in prior art will be prevented in the invention.

The advantage and spirit of the invention may be further understood by the following recitations together with the appended drawings.

### BRIEF DESCRIPTION OF THE APPENDED DRAWINGS

FIG. 1 shows a functional block diagram of the mobile communication apparatus in the first embodiment according to the invention.

FIG. 2 shows a flowchart of the mobile communication apparatus operating method in the second embodiment according to the invention.

### DETAILED DESCRIPTION OF THE INVENTION

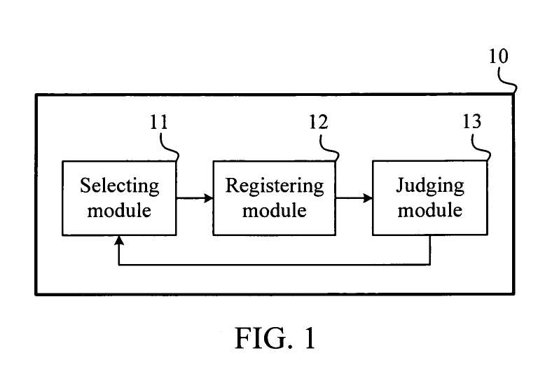

A first embodiment according to the invention is a mobile communication apparatus. Please refer to FIG. 1. FIG. 1 shows a functional block diagram of the mobile communication apparatus. As shown in FIG. 1, the mobile communication apparatus 10 comprises a selecting module 11, a registering module 12, and a judging module 13.

When the mobile communication apparatus 10 is powered on, the mobile communication apparatus 10 will automatically search wireless communication networks near the mobile communication apparatus 10. The selecting module 11 is used for selecting a first preferred network from at least one communication network near the mobile communication apparatus 10. In practical applications, the selecting module 11 usually selects a communication network with the strongest signal as the first preferred network from the at least one communication network. The registering module 12 is coupled to the selecting module 11, and the registering module 12 is used for performing a first network registration on the first preferred network. The judging module 13 is coupled to the selecting module 11 and the registering module 12. When the first network registration is rejected by the first preferred network, the judging module 13 will judge whether the mobile communication apparatus 10 is under a roaming state or not. If the judgment of the judging module 13 is yes, the judging module 13 will control the selecting module 11 to reselect a second preferred network.

That is to say, when the first network registration is rejected by the first preferred network (i.e., the mobile communication apparatus 10 receives a rejection code of “illegal mobile phone” from the first preferred network), the mobile communication apparatus 10 will not be judged as “illegal mobile phone” immediately. As mentioned above, the judging module 13 will judge whether the mobile communication apparatus 10 is under the roaming state firstly, and then determine whether the mobile communication apparatus 10 can further select other available networks. With that, the mobile communication apparatus according to the invention can solve the failure condition the user meets when he/she uses a dual-mode mobile phone to roam in the prior art.

In practical applications, the mobile communication apparatus 10 can further comprise a converting module (not shown in the figures). The converting module is coupled to the judging module 13. Then, the two possible conditions according to the judgment of the judging module 13 will be discussed.

The first condition is, if the judgment of the judging module 13 is yes, namely the mobile communication apparatus 10 is under the roaming state, and then the converting module will convert the rejection code into a service unavailable message. For example, if the first preferred network is a 3G network and the mobile communication apparatus 10 is under the roaming state, the service unavailable message would be “3G network service is not available in this area currently”. That is to say, the mobile communication apparatus 10 can not use the roaming function via the 3G network in this area. However, this does not mean that the mobile communication apparatus 10 can not select other network services to register.

The second condition is, if the judgment of the judging module 13 is no, namely the mobile communication apparatus 10 is not under the roaming state, and then the converting module will convert the rejection code into a rejection message. For example, if the first preferred network is a 3G network and the mobile communication apparatus 10 is not under the roaming state, the rejection message means that the mobile communication apparatus 10 may be an illegal mobile phone, so that the mobile communication apparatus 10 will be rejected to use any network services.

Additionally, the mobile communication apparatus 10 can further comprise a displaying module (not shown in the figures). The displaying module is coupled to the converting module and used to display the service unavailable message or the rejection message.

After the first preferred network accepts the first network registration, the registering module 12 will generate a first successful message, and then the mobile communication apparatus 10 can use the first preferred network.

On the other hand, after the judging module 13 selects the second preferred network, the registering module 12 can perform a second network registration on the second preferred network. After the second preferred network accepts the second network registration, the registering module 12 will generate a second successful message, and then the mobile communication apparatus 10 can use the second preferred network. When the first network registration is rejected by the first preferred network, the first preferred network will transmit a rejection code to the mobile communication apparatus 10.

In practical applications, the first preferred network can be a 3G mobile communication network and the second preferred network can be a 2G mobile communication network; or the first preferred network can be a 2G mobile communication network and the second preferred network can be a 3G mobile communication network.

For example, if a user takes a business trip to a foreign country and brings a 2G/3G dual-mode mobile phone according to the invention, and the local communication network service provider in that country can only provide the 2G network roaming service to the user's mobile phone. When the user uses the mobile phone to roam, if the 3G network signal is stronger than the 2G network signal in that area, the mobile phone will select the 3G network to register firstly. However, because the local communication network service provider does not provide the 3G network roaming service to the user, thus, the registration of the mobile phone will be rejected.

At this time, the 3G network will transmit a rejection code to the mobile phone. Then, it is judged whether the mobile phone is under the roaming state. Because the mobile phone is actually under the roaming state, so that the rejection code will be converted into a service unavailable message such as a message of “3G network service is not available in this area currently” and the service unavailable message is shown on the monitor of the mobile phone. At the same time, the mobile phone will reselect an available 2G network and register. Since the local communication network service provider provides the 2G network roaming service to the user, the mobile phone can successfully register on the 2G network and use the 2G network roaming service.

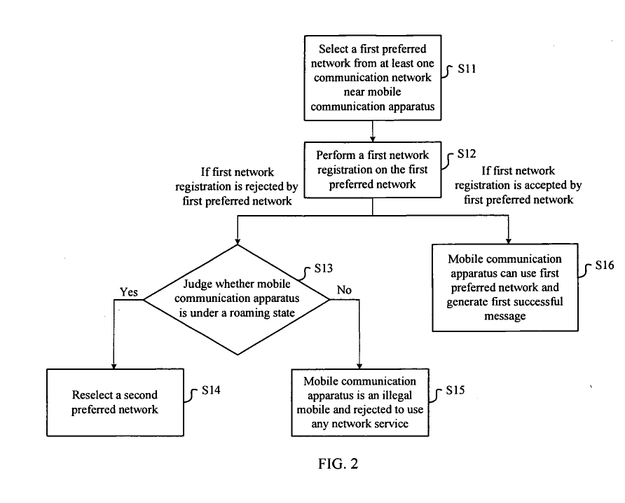

A second embodiment according to the invention is a mobile communication apparatus operating method. Please refer to FIG. 2. FIG. 2 shows a flowchart of the mobile communication apparatus operating method. As shown in FIG. 2, at first, the method performs step S11 to select a first preferred network from at least one communication network near the mobile communication apparatus. Then, the method performs step S12 to perform a first network registration on the first preferred network. According to whether the first preferred network accepts the first network registration, two possible conditions will be discussed.

The first possible condition is, if the first network registration is rejected by the first preferred network, then the method performs step S13 to judge whether the mobile communication apparatus is under a roaming state. If the judgment of step S13 is yes, namely the mobile communication apparatus is under the roaming state, then the method will perform step S14 to reselect a second preferred network. If the judgment of step S13 is no, namely the mobile communication apparatus is not under the roaming state, then step S15 is perform, the mobile phone will be seen as an illegal mobile phone and rejected to use any other networks.

Another possible condition is, if the first network registration is accepted by the first preferred network, then the method will perform step S16, the mobile communication apparatus can use the first preferred network and generate a first successful message.

Additionally, after step S14 is performed to reselect the second preferred network, the method can perform a second network registration on the second preferred network. If the second network registration is accepted by the second preferred network, then the method can generate a second successful message. At this time, the mobile communication apparatus can start to use the second preferred network.

In practical applications, if the first network registration is rejected by the first preferred network, then the first preferred network will transmit a rejection code to the mobile communication apparatus. If the judgment of the step S13 is yes, namely the mobile communication apparatus is under a roaming state, the method can convert the rejection code into a service unavailable message, for example, a message of “3G network roaming service is not provided in this area”. If the judgment of the step S13 is no, namely the mobile communication apparatus is not under a roaming state, the method can convert the rejection code into a rejection message, for example, a message of “this mobile phone is rejected to use any network services”. Moreover, the method can further display the service unavailable message or the rejection message.

Compared with the prior art, the mobile communication apparatus and the mobile communication apparatus operating method can overcome the blind spot of the network roaming service setup of the communication network service provider, so that when the mobile communication apparatus performs the roaming function, even if the registration of the mobile communication apparatus on a communication network is rejected, the mobile communication apparatus can still use other available communication networks. Additionally, users can also use the network services provided by the communication network service providers via the mobile communication apparatus according to the invention with more choices.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A mobile communication apparatus, comprising:
a selecting module, for selecting a first preferred network from at least one communication network near the mobile communication apparatus;
a registering module, coupled to the selecting module, for performing a first network registration on the first preferred network; and
a judging module, coupled to the selecting module and the registering module, when the first network registration is rejected by the first preferred network, the judging module judging whether the mobile communication apparatus is under a roaming state, if the judgment of the judging module is yes, the judging module controls the selecting module to reselect a second preferred network.

2. The mobile communication apparatus of claim 1, wherein the selecting module selects a communication network with the strongest signal as the first preferred network from the at least one communication network.

3. The mobile communication apparatus of claim 1, wherein the first preferred network is a 3G mobile communication network and the second preferred network is a 2G mobile communication network, or the first preferred network is a 2G mobile communication network and the second preferred network is a 3G mobile communication network.

4. The mobile communication apparatus of claim 1, wherein after the first preferred network accepts the first network registration, the registering module generates a first successful message, and then the mobile communication apparatus can use the first preferred network.

5. The mobile communication apparatus of claim 1, wherein after the judging module selects the second preferred network, the registering module performs a second network registration on the second preferred network.

6. The mobile communication apparatus of claim 5, wherein after the second preferred network accepts the second network registration, the registering module generates a second successful message, and then the mobile communication apparatus can use the second preferred network.

7. The mobile communication apparatus of claim 1, wherein when the first network registration is rejected by the first preferred network, the first preferred network transmits a rejection code to the mobile communication apparatus.

8. The mobile communication apparatus of claim 7, further comprising:
a converting module, coupled to the judging module, if the judgment of the judging module is yes, the converting module converts the rejection code into a service unavailable message.

9. The mobile communication apparatus of claim 8, wherein if the judgment of the judging module is no, the converting module converts the rejection code into a rejection message.

10. The mobile communication apparatus of claim 9, further comprising:
a displaying module, coupled to the converting module, for displaying the service unavailable message or the rejection message.

11. A method of operating a mobile communication apparatus, comprising the steps of:
(a) selecting a first preferred network from at least one communication network near the mobile communication apparatus;
(b) performing a first network registration on the first preferred network;
(c) when the first network registration is rejected by the first preferred network, judging whether the mobile communication apparatus is under a roaming state; and
(d) if the judgment of step (c) is yes, reselecting a second preferred network.

12. The method of claim 11, wherein a communication network with the strongest signal is selected as the first preferred network from the at least one communication network.

13. The method of claim 11, wherein the first preferred network is a 3G mobile communication network and the second preferred network is a 2G mobile communication network, or the first preferred network is a 2G mobile communication network and the second preferred network is a 3G mobile communication network.

14. The method of claim 11, further comprising the step of:
(e) generating a first successful message after the first preferred network accepts the first network registration, and then the mobile communication apparatus can use the first preferred network.

15. The method of claim 11, further comprising the step of:
(f) performing a second network registration on the second preferred network after the second preferred network is selected.

16. The method of claim 15, further comprising the step of:
(g) generating a second successful message after the second preferred network accepts the second network registration, and then the mobile communication apparatus can use the second preferred network.

17. The method of claim 11, wherein when the first network registration is rejected by the first preferred network, the first preferred network transmits a rejection code to the mobile communication apparatus.

18. The method of claim 17, further comprising the step of:
(h) if the judgment of step (c) is yes, converting the rejection code into a service unavailable message.

19. The method of claim 18, further comprising the step of:
(i) if the judgment of step (c) is no, converting the rejection code into a rejection message.

20. The method of claim 19, further comprising the step of:
j) displaying the service unavailable message or the rejection message.
